(19) United States
(12) Patent Application Publication
(10) Pub. No.: US 2007/0087608 A1
(43) Pub. Date: Apr. 19, 2007

(54) Delivery Device and Method

(76) Inventor: Der-Yang Tien, Encinitas, CA (US)

Correspondence Address: SHOEMAKER AND MATTARE, LTD, 10 POST OFFICE ROAD - SUITE 110, SILVER SPRING, MD, 20910, US

(21) Appl. No.: 11/465,872

(22) Filed: Aug. 21, 2006

(30) Foreign Application Priority Data
Oct. 18, 2005 (TW) 094136266

(51) Int. Cl. H01R 13/62

(52) U.S. Cl. 439/312

(57) ABSTRACT

A delivery device and a delivery method allow at least one substance to permeate through the skin. The delivery device includes at least a receiving member, a conductive member, and a controlling member. After the receiving member for storing the substance comes into contact with the skin, an electric field is generated within the receiving member, thereby micronizing molecules of the substance to allow the substance to permeate through the skin from the receiving member in a manner of electrophoresis or iontophoresis.

### FIELD OF THE INVENTION

The present invention relates to delivery devices and methods for administration of medicine, and more particularly, to a delivery device and method for transdermal administration.

### BACKGROUND OF THE INVENTION

Due to the barrier function of skin, molecular transport through skin is hindered. In order to transport medicine through skin, painful subcutaneous injection with a needle is widely used. For example, most diabetic people must stand the pain of pricking a finger with a pin to obtain blood glucose measurements and many also need to regularly inject insulin by needle. Such an injection regimen is a nightmare for many diabetics, especially when the needle penetrates into the skin.

Meanwhile, some people are not capable of self-injection, so it is very inconvenient for them, particularly if they need to go to hospital or ask professional persons to inject medicine for them. Although an injection pump is available that allows people needing medicine long-term to live relatively normal lives, such an injection pump must be strapped to the user's waist and is big in size, complicated to operate, and expensive, such that its application is limited.

Furthermore, patients who forego injecting while traveling due to lack of injection skill or the lack of an injection pump can seriously jeopardize their health.

Additionally, microscission, a method for transporting medication into the body, was developed by a Harvard-MIT research group as an alternative delivery method. Compared to subcutaneous injection, microscission removes the stratum corneum by way of a gas stream with irregular aluminum oxide particles that range in size from 10 to 70 μm in diameter, forming about 250 μm diameter small holes. Such a method can avoid pain due to minimal impact to dermal nerves. However, microscission still requires professional injection skill and regular people cannot utilize microscission to inject medication by themselves. Therefore, microscission is still not widely used.

Because the prior art medication delivery techniques have the disadvantages of being difficult to inject by oneself, inconvenient to use, and expensive, thus increasing the likelihood of health problems due to missed doses, it is desirable to provide a method for delivering medication through the skin into the subcutaneous tissue without the need of needles or other invasive elements, thereby improving convenience and lowering costs.

### SUMMARY OF THE INVENTION

To overcome the aforementioned problems, it is a primary objective of the present invention to provide a delivery device and method to allow a substance such as medicine to permeate through skin without invasive elements.

It is another objective of the present invention to provide a delivery device and method that can enhance convenience.

It is a further objective of the present invention to provide a delivery device and method that can lower costs.

It is still another objective of the present invention to provide a delivery device and method that can improve flexibility for application.

To achieve the above and other objectives, the present invention discloses a delivery device and method allowing at least one substance to permeate through skin. The delivery device comprises at least a receiving member, a conductive member, and a controlling member, wherein the receiving member allows the substance to be kept in the receiving member and in contact with skin; the conductive member is electrically connected with the receiving member and also in contact with the skin; and the controlling member applies various voltages to the conductive member to generate an electric field in the receiving member to control the permeation of the substance through the skin. The delivery method comprises at least the steps of: providing a receiving member for containing a substance and disposing the receiving member in contact with skin; generating an electric field within the receiving member; and causing the substance to permeate through the skin from the receiving member.

Preferably, the receiving member is disposed on a watch and can be opened to refill or replace the substance in the receiving member after use. The receiving member and the watch may be formed together into one structure, or the receiving member and the watch can be separable from each other. The receiving member has at least one accommodating space for storing the substance and at least one outlet member for releasing the substance, wherein the outlet member is a hole or an opening. The receiving member serves to store the substance, the substance being able to permeate through skin by the method of electrophoresis or iontophoresis. The conductive member comprises a first contacting member and a second contacting member, wherein the first contacting member serves as a first electrode and the second contacting member serves as a second electrode. The conductive member may further comprise at least one conductive wire.

In one preferred embodiment, the controlling member comprises a driver that is electrically connected with the receiving member and the conductive member, and serves to apply voltages to the conductive member; a digital clock counter that periodically controls the applied voltages at intervals of a predetermined time; and a microprocessor that continuously loads the digital clock counter with time intervals, thereby setting the time intervals for delivering the substance.

In another preferred embodiment, the controlling member comprises a driver that is electrically connected with the receiving member and the conductive member, and serves to apply voltages to the conductive member; a quantitative controller that serves to control the voltages applied by the driver; and a controlling interface that serves to control the quantitative controller. The user can set parameters for transporting the substance, for example, time intervals, dosages, and so on. The driver may be equipped with batteries and is connected with the conductive member to supply power. Herein, the driver may be an electrical power supply and the controlling interface may be, for example, arranged on the face of a watch to display figures or characters of a plurality of parameters for operation, thus allowing the user to input the desired parameters based on individual needs.

In a further preferred embodiment, the controlling interface may be preset with several delivery modes and may display one or more performance parameters selected from the group consisting delivery mode, selected mode, proceeding time, remaining time, remaining cycles, and remaining dosage, thus allowing the user to receive a suitable dosage at suitable times according to the user's requirements to carry out the desired delivery mode, wherein, in this case, the user is not able to self-adjust the desired dosage without the assistance of a professional.

As to the delivery method, in one preferred embodiment, in the step of providing a receiving member for containing a substance and disposing the receiving member to be in contact with the skin, the receiving member is integrated into a watch and voltages are applied thereto according to predetermined time intervals. In another preferred embodiment, prior to generating an electric field within the receiving member, the delivery method further comprises a step of setting parameters for delivering the substance, thus generating electric fields within the receiving member based on the parameters, wherein one or more parameters are selected from the group consisting of dosage, delivery interval of time, and delivery time. In a further preferred embodiment, prior to generating an electric field within the receiving member, the delivery method further comprises a step of selecting the delivery mode, thus generating an electric field within the receiving member based on the delivery mode.

Preferably, in the step of generating an electric field within the receiving member, a low frequency current is employed, thereby micronizing molecules of the substance. Then the substance permeates through the skin from the receiving member in a manner of electrophoresis or iontophoresis.

Compared to prior art, the present invention provides a delivery device and method that can micronize molecules of a substance and allow the substance to permeate through the skin without invasive elements. Therefore, the problems of pain and inconvenience in self-injection of the conventional technology can be avoided.

Meanwhile, the user can readily use the present invention in his everyday life. The present invention can not only overcome the tendency of patients to forego injection due to pain, inconvenience, and costs, but also can enhance the flexibility of operation, thus better maintaining users' health. Moreover, the present invention can be widely applied within the existing structure of the healthcare system.

### BRIEF DESCRIPTION OF THE DRAWINGS

FIG. 1 is a structural block diagram illustrating the delivery device of the first embodiment according to the present invention;

FIG. 2 is a schematic diagram partially illustrating the structure of FIG. 1 in application;

FIG. 3 is a detailed structural block diagram of FIG. 1;

FIG. 4 is a flowchart illustrating the delivery method of the first embodiment according to the present invention;

FIG. 5 is a structural block diagram illustrating the delivery device of the second embodiment according to the present invention;

FIG. 6 is a flowchart illustrating the delivery method of the second embodiment according to the present invention;

FIG. 7 is a structural block diagram illustrating the delivery device of the third embodiment according to the present invention; and

FIG. 8 is a flowchart illustrating the delivery method of the third embodiment according to the present invention.

### DETAILED DESCRIPTION OF THE PREFERRED EMBODIMENTS

The following descriptions of the detailed embodiments are only to disclose the features and functions of the present invention and are not intended to limit the scope of the present invention. It should be understood that the delivery device and method allow at least one substance to permeate through the skin, and the substances in the following embodiments are merely exemplified, and not restricted to the present disclosure.

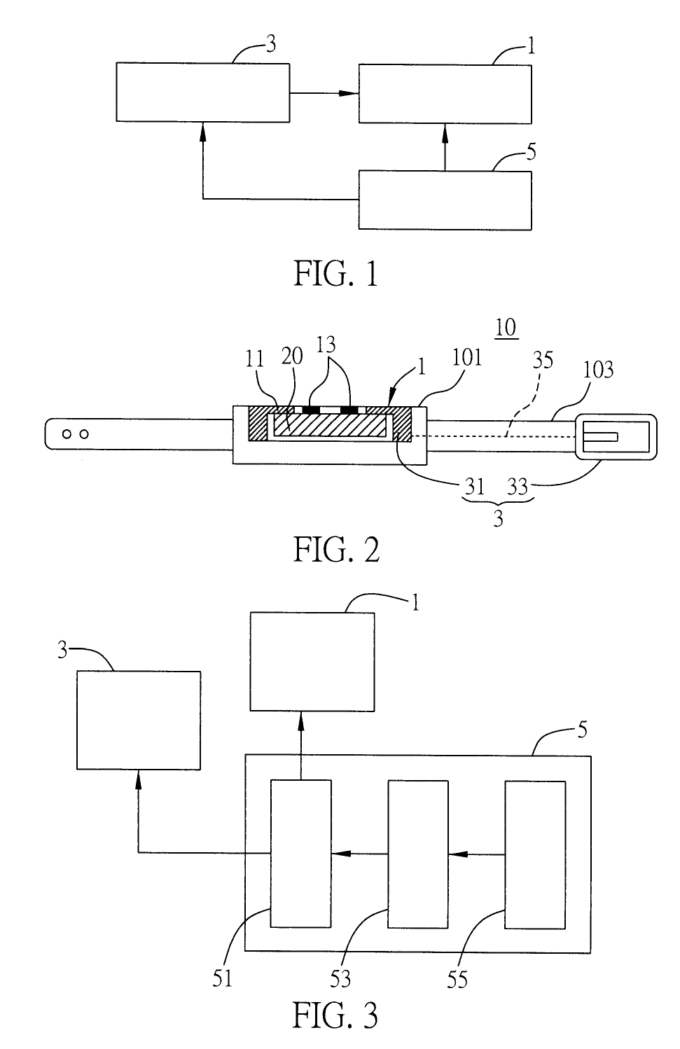

FIGS. 1 to 4 are drawings showing the delivery device and method of the first embodiment according to the present invention. As shown in FIG. 1, the delivery device comprises a receiving member 1 (such as a reservoir), a conductive member 3, and a controlling member 5, wherein the receiving member 1 serves to store a substance which can permeate through skin by the methods of electrophoresis, iontophoresis, and the like, the receiving member 1 being in contact with skin. As shown in FIG. 2, the receiving member 1 is arranged, for example, at the rear side of a watch body 101 of a watch 10, and the receiving member 1 has an accommodating space 11 such as a recessed area disposed at the rear side of the watch body 101 to store the substance 20. Meanwhile, the receiving member 1 has at least one outlet member 13 for releasing the substance 20. In this embodiment, two outlet members 13 are provided. The outlet member 13 may be, but is not limited to, a hole, an opening, and the like.

Although the receiving member 1 has one accommodating space 11 in this embodiment, it is understood by those skilled in the art that the receiving member 1 may have a plurality of accommodating spaces 11 for respectively storing various substances. Furthermore, in this embodiment, the receiving member 1 is disposed in a watch 10 and can be opened to refill or replace the substance 20 after depletion. However, in other embodiments, the receiving member 1 may be assembled to the watch 10 and detachable such that the receiving member 1 can be directly replaced when the substance 20 is depleted or other substances need to be administered.

The conductive member 3 is electrically connected with the receiving member 1 and in contact with the skin. As shown in FIG.2, the conductive member 3 may be disposed in the watch 10 and comprises a first contacting member 31 arranged in the watch body 101 and a second contacting member 33 arranged to one end of a watchband 103 which is joined with the watch body 101, wherein the second contacting member is, for example, but not limited to, a watchband buckle.

Further, the first contacting member 31 may serve as a first electrode such as a positive electrode and the first contacting member 31 partially covers the receiving member 1 to facilitate electrical conduction. The second contacting member 33 may serve as a second electrode such as a negative electrode to allow the receiving member 1 to generate an electric field when voltage is applied thereto. Alternatively, in other embodiments, the first contacting member 31 may serve as a first electrode such as a negative electrode and the second contacting member 33 may serve as a second electrode such as a positive electrode. It depends on the design factors and is not limited to the cases mentioned in this embodiment.

Additionally, the conductive member 3 further comprises at least one electric wire 35, wherein the electric wire 35 may be, but not limited to, embedded in the watchband 103. For example, the electric wire 35 may extend from the watchband 103 at the ends and is fixed by a structure disposed in the watchband 103, such as a concave, a rail, a slot and the like.

The controlling member 5 serves to apply voltages to the conductive member 3, thus allowing the receiving member 1 to generate an electric field and controlling the substance 20 to permeate the skin. In this embodiment, the controlling member 5 may also be disposed on the watch 10. Moreover, as shown in FIG. 3, the controlling member 5 may comprise a driver 51 that is electrically connected with the receiving member 1 and the conductive member 3 and serves to apply voltages to the conductive member 3; a digital clock counter 53 which cyclically controls the applied voltages at predetermined time intervals; and a microprocessor 55 which continuously loads the digital clock counter 53 with the time intervals. In consideration of the stimulation and damage to the skin caused by electric current, the electric current applied is typically less than 5 mA/cm². Since the voltages applied by the driver 51 are not high, batteries (not shown) in the watch 10 can be used to supply power such that an extra power source is not necessary.

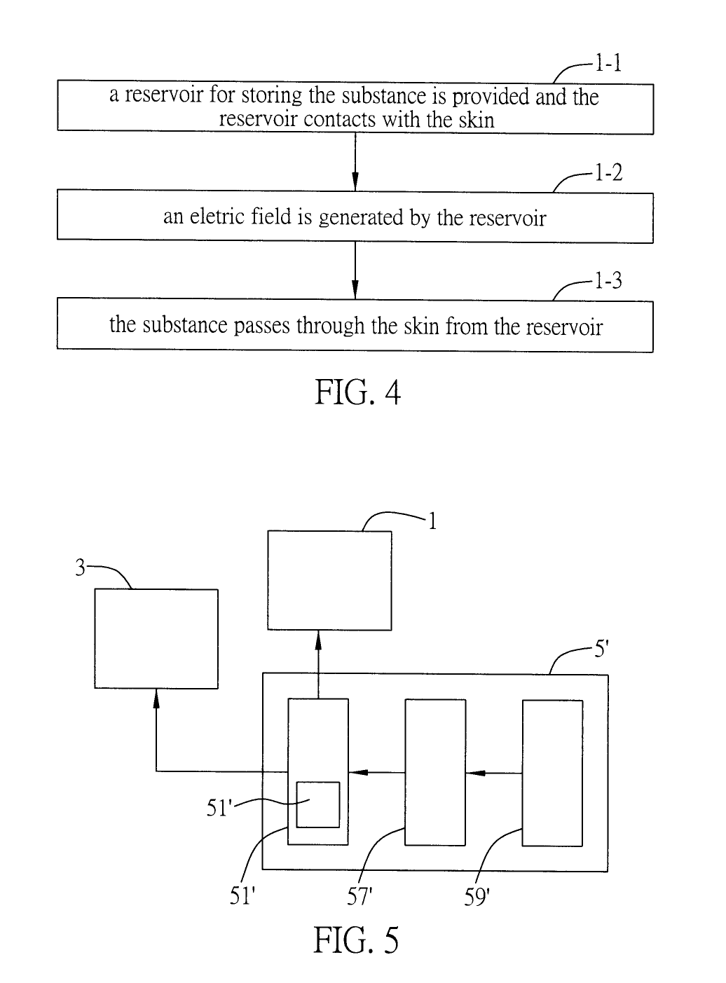

A method for delivering at least one substance through skin that applies the delivery device of the present invention is shown in FIG. 4. As shown in FIG. 4, in the step 1-1, a receiving member 1 for storing the substance 20 is provided and the receiving member 1 is in contact with the skin. In this embodiment, the watch 10 may be worn on the wrist and the receiving member 1 directly contacts with the skin. In step 1-2, an electric field is generated within the receiving member 1. In this embodiment, the driver 51 can be periodically controlled to apply voltages by the digital clock counter 53 according to the predetermined time intervals by the microprocessor 55 of the controlling member 5 in the watch 10, such that the voltages are applied to the conductive member 3 and the an electric field is generated within the receiving member 1. In step 1-3, the substance 20 passes through the skin from the receiving member 1. In this embodiment, an electric field allowing molecules of the substance 20 to be micronized into molecules with molecular weight less than 10,000 is generated by the receiving member 1, thus the substance 20 in the receiving member 1 is transdermally delivered to the dermis.

In this embodiment, the substance 20 may include, for example, gel or liquid containing medicine, tablets, powders, ointments, pills, nutrients and the like, which can permeate through skin by the method of electrophoresis, iontophoresis and the like. The term “electrophoresis” refers to the technique in which charged particles migrate toward the electrode with opposite charge under the influence of an electric field. The electrophoresis technique may be employed in electrocardiogram measurements. The term “iontophoresis” refers to the technique in which the electron current would be transformed into ion current under the influence of an electric field, and the ion current would be transformed back into electron current in the dermis after the ion current passes through skin. In this embodiment, molecules of the substance are micronized by these techniques with low amperage current (for example, but not limited to, 5 mA/cm²), thereby transdermally administrating medicine. Because the principles and effects of these aforementioned techniques such as electrophoresis and iontophoresis are well known, they are not further discussed herein.

Moreover, the interval of time and the dosage for transporting the desired substance can be preset. Since the interval of time and the dosage for transporting the substance may be preset on the basis of the user's requirement, there are different predetermined values for different users. Meanwhile, different substances have different transporting rate and associated parameters. These are readily varied by those skilled in the art, and therefore these variations are not further described herein.

Accordingly, the user can deliver the desired substance to the dermis without complicated operations or professional skill. For example, for the user needing to inject medicine long-term, the user can utilize the time-counting function of the watch 10 to allow the receiving member 1 of the delivery device to generate an electric field periodically at corresponding predetermined time intervals controlled by the microprocessor 55, therefore the user does not need to pay attention to the time of day as with prior art delivery methods. Additionally, for a user needing to get up at a specific time, a substance such as caffeine delivered at specific time (for example, 5 o'clock every morning) can help to either awake the user or make the user more alert on awakening. For the user needing to drive a car for a long time or work overnight, a substance such as caffeine delivered periodically (for example, every 50 minutes) can help the user be more alert.

Compared to conventional technologies, the present invention can directly deliver a substance through the skin to the dermis. Pain can be avoided and professional injection skill is not necessary, and the average person can conveniently add the desired medicine or substances by themselves. Because medicine and substances can be added by users themselves in the present invention, the present invention is convenient to use. Moreover, since the present invention can be combined with general accessories such as a wristwatch, it not only has the advantages of lower cost and easier carrying, but it can also prevent the situation of a user forgetting to regularly and timely administer his or her medicine.

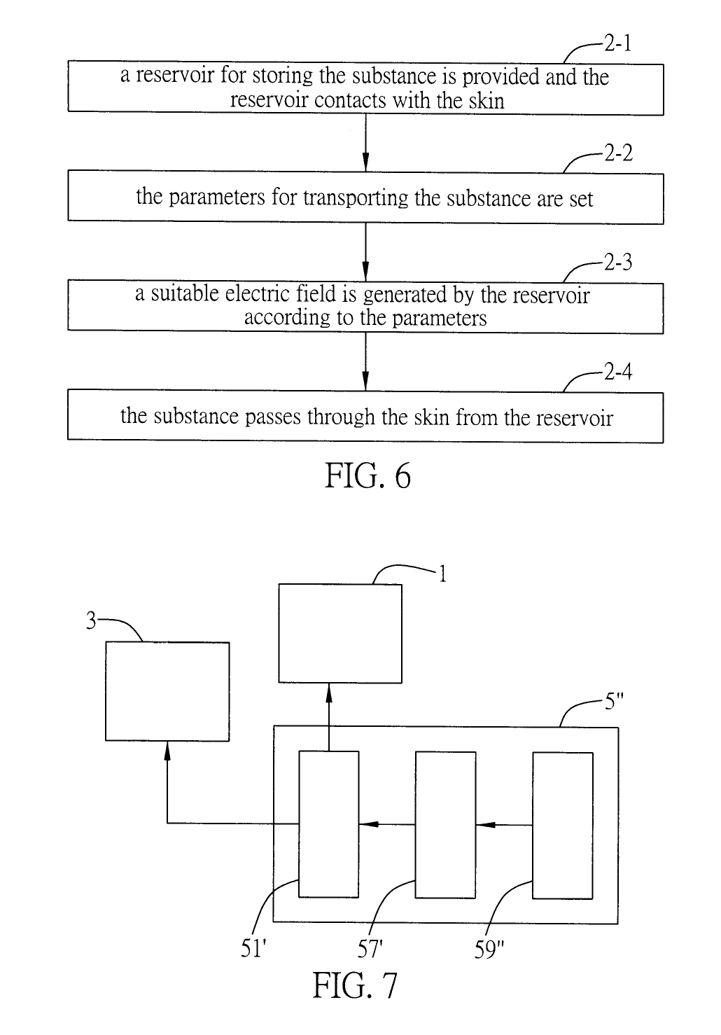

FIG. 5 and FIG. 6 show the delivery device of the second embodiment according to the present invention. In the second embodiment, matching reference numerals denote corresponding elements in the first embodiment and the details are not repeated herein.

The difference between the first embodiment and the second embodiment is that the interval of time for transporting a substance is preset in the first embodiment while parameters for transporting the substance, such as the interval of time, dosage and so on, can be set by the user in the second embodiment.

As shown in FIG. 5, the controlling member 5′ may comprise a driver 51′ that is electrically connected with the receiving member 1 and the conductive member 3 and serves to apply voltages to the conductive member 3; a quantitative controller 57′ that serves to control the voltages applied by the driver 51′; and a controlling interface 59′ that serves to control the quantitative controller 57′. The controlling interface 59′ may be, for example, arranged on the face of a watch to display figures or characters of a plurality of parameters for operation, thus allowing the user to input the desired parameters such as dosage, delivery interval, delivery time and other associated parameters, based on user needs. The quantitative controller 57′ controls the driver 51′ to generate a suitable voltage, thus the performing drug delivery. Further, the driver 51′ in this embodiment may be equipped with a battery 511′ and is connect with the conductive member 3 to supply power. Therefore, the driver 51′ in this embodiment may be a power supply.

As shown in FIG. 6 in conjunction with FIG. 5, in step 2-1, a receiving member 1 for storing a substance 20 is provided and the receiving member 1 is in contact with skin. In step 2-2, the parameters for transporting the substance 20 are set. In this embodiment, the desired parameters such as dosage, delivery interval, delivery time and other associated parameters can be input through the controlling interface 59′. In step 2-3, a suitable electric field is generated within the receiving member 1 according to the aforementioned parameters. In this embodiment, because the controlling interface 59′ can control the driver 51′ to apply voltage in response to the quantitative controller 57′ based on the aforementioned parameters, a proper voltage can be applied to the conductive member 3 to allow an electric field to be generated within the receiving member 1. In the step 2-4, the substance 20 is micronized in the force of the electric field, thus the substance 20 in the receiving member is transdermally delivered to subcutaneous tissues, for example, permeating into the bloodstream through sweat glands, hair follicles and pores.

For example, for a user needing to drink alcoholic beverages with others, a substance such as a liquid for preventing drunkenness or a substance having components capable of reducing drunkenness can be stored in the receiving member 1, and the desired parameters such as dosage, delivery interval, delivery time and other associated parameters can be input in advance, thereby the substance for preventing or reducing drunkenness can be delivered periodically with a specific amount and the situation of drunkenness can be avoided or reduced. Additionally, for a user desiring to cease smoking, a substance such as nicotine or a substitute of nicotine or other substance having helpful effects for helping smokers quit can be stored in the receiving member 1, and, after setting the associated parameters, the substance can be delivered through the user's skin to help break the habit of smoking.

Alternatively, the substance 20 may also be vitamins, health supplements, or other desired substances. Although substances that cannot be administrated orally (because these substances would be destroyed by gastric acid or cannot be absorbed by the intestines) are exemplified, other substances that can be administrated orally may also be applied in the present invention, providing convenience to the user in terms of not needing to carry bulky containers and also by eliminating the need for the user to remember to take and go through the process of orally taking such substances. The various uses of the above mentioned substances are all easily understood by those skilled in the art, so they are not described herein.

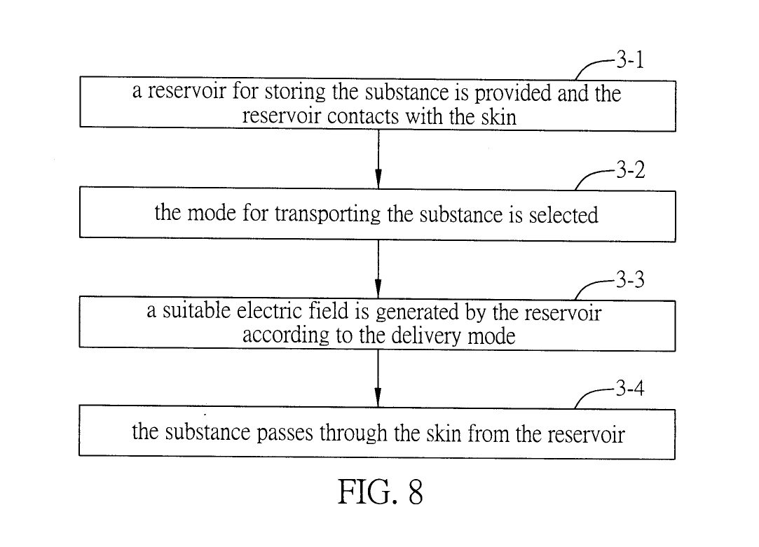

FIG. 7 and FIG. 8 show the delivery device of the third embodiment according to the present invention. In the third embodiment, matching reference numerals denote corresponding elements in the aforementioned embodiments and the details are not repeated.

The difference between the third embodiment and the second embodiment is that the parameters for transporting the substance, such as the interval of time, dosage and so on, can be preset (via delivery modes) in the third embodiment rather than set by the user as in the second embodiment.

As shown in FIG. 7, the controlling member 5″ may comprise a driver 51′ that is electrically connected with the receiving member 1 and the conductive member 3 and serves to apply voltages to the conductive member 3; a quantitative controller 57′ that serves to control the voltages applied by the driver 51′; and a controlling interface 59″ that serves to control the quantitative controller 57′. The difference between the controlling interface 59″ in the third embodiment and the controlling interface 59′ in the second embodiment is that several delivery modes are preset in the controlling interface 59″, such as the delivery mode, selected mode, proceeding time, remaining time, remaining cycles, remaining dosage and so on, thereby facilitating easy user operation.

As shown in FIG. 8 in conjunction with FIG. 7, in step 3-1, a receiving member 1 for storing a substance 20 is provided and the receiving member 1 is in contact with the skin. In step 3-2, the mode for transporting the substance 20 is selected. In this embodiment, a preset delivery mode is selected through the controlling interface 59″. The content of the delivery mode is set according to, for example, but not limited to, the severity of the disease, body temperature and so on. In step 3-3, an electric field is generated within the receiving member 1 according to the aforementioned delivery mode. In this embodiment, since the controlling interface 59″ can control the driver 51′ to give a suitable voltage through the quantitative controller 57′ based on the aforementioned delivery mode, a proper voltage can be applied to the conductive member 3 to allow an electric field to be generated within the receiving member 1. In step 3-4, the substance 20 is micronized in the force of the electric field, and thus the substance 20 in the receiving member 1 is transdermally delivered to subcutaneous tissues.

Therefore, even though the user is not able to formulate the desired dosage or the desired dosage should be professionally modified, an excessive amount of dosage would not be delivered to the subcutaneous tissues and the desired delivery mode can be performed based on user's requirement, thus the proper dosage can be delivered at the proper time. Meanwhile, a steady flow of the substance can be assured through the controlling interface 59″, which can display the performance status such as the delivery mode, selected mode, proceeding time, remaining time, remaining cycles, remaining dosage and so on, and, even if the condition of the user changes (for example, catching cold, pressure, body temperature and severity of disease varied), the delivery mode can be easily adjusted.

For example, in the case of a user having hand pain, a substance such as an analgesic or other substance having components capable of relieving pain and inflammation can be stored in the receiving member 1. When the user feels somewhat uncomfortable, the user may select a delivery mode for a dosage for less severe symptoms; and when the user feels stronger discomfort, the user may select a delivery mode for a dosage for more severe symptoms.

Moreover, in order to make the substance more easily permeate through the skin, a carrier substance facilitating electrical conduct can be used. For example, the substance can be blended with gel, water, saline or other carriers that can increase electrical conductivity. The substance, for example, gel containing medicine, can also be directly applied to the skin, and thus the outlet member 13 can be omitted. Additionally, other substances that can more easily permeate through the skin are also suitable in the present invention. For example, mint oil or other substances that can enlarge pores can be daubed on the site of the skin at the site where delivery of the substance is intended; or such substances can accentuate conductivity between the receiving member and the skin. It is also possible to dispose a metal layer or other facilitative conductive material on the receiving member. Namely, all the methods that facilitate electrical conductivity and allow the molecules of the substance to permeate through the skin in response to an electric field are suitable to the present invention. Therefore, these various aspects of the present invention are not described in detail herein.

Compared to the conventional technologies, the present invention has various utilization scenarios and the various scenarios in the aforementioned embodiments can be replaced and combined, and thereby the shortcomings of the conventional technologies such as inability or failure to self-inject, inconvenient usage, and expense, all of which compromise the user's health, can be overcome and the present invention can also be widely applied due to the enhanced flexibility.

The foregoing detailed descriptions of the embodiments have been presented for illustrating the features and functions of the present invention and not for limiting the scope of the present invention. Those skilled in the art will appreciate that various modifications and variations may be made according to the spirit and principle of the present invention. Such modifications and variations are considered to fall within the spirit and scope of the present invention as defined by the appended claims.

What is claimed is:

1. A delivery device for allowing at least one substance to permeate through skin, comprising:
a receiving member for containing the substance and for being in contact with skin;
a conductive member electrically connected with the receiving member and in contact with the skin; and
a controlling member applying voltages to the conductive member to generate an electric field within the receiving member, thereby causing the substance to permeate from the receiving member through the skin.

2. The delivery device of claim 1, wherein the receiving member is detachably disposed on a watch and is opened to refill or replace the substance.

3. The delivery device of claim 1, wherein the receiving member has at least one accommodating space for storing the substance correspondingly.

4. The delivery device of claim 1, wherein the receiving member has at least one outlet member for releasing the substance.

5. The delivery device of claim 1, wherein the receiving member serves to store the substance that is allowed to permeate through skin in a manner of electrophoresis or iontophoresis.

6. The delivery device of claim 1, wherein the conductive member comprises a first contacting member and a second contacting member.

7. The delivery device of claim 6, wherein the first contacting member serves as a first electrode.

8. The delivery device of claim 7, wherein the second contacting member serves as a second electrode.

9. The delivery device of claim 1, wherein the controlling member comprises a driver which is electrically connected with the receiving member and the conductive member and serves to apply voltages to the conductive member;
a digital clock counter which cyclically controls the applied voltages at intervals of a predetermined time; and
a microprocessor which continuously loads the digital clock counter with the time intervals.

10. The delivery device of claim 1, wherein the controlling member comprises a driver which is electrically connected with the receiving member and the conductive member and serves to apply voltages to the conductive member;
a quantitative controller which serves to control the voltages applied by the driver; and
a controlling interface which serves to control the quantitative controller.

11. The delivery device of claim 10, wherein the controlling interface is arranged on a face of a watch to display figures or characters of a plurality of operating parameters.

12. The delivery device of claim 10, wherein the controlling interface displays one or more performance characteristics including delivery mode, selected mode, proceeding time, remaining time, remaining cycles and remaining dosage.

13. A delivery method for allowing at least one substance to permeate through skin, comprising the steps of: providing a receiving member for containing the substance, wherein the receiving member is in contact with the skin;
generating an electric field within the receiving member; and causing the substance to permeate through the skin from the receiving member.

14. The delivery method of claim 13, wherein in the step of providing a receiving member for containing the substance, the receiving member is disposed on a watch.

15. The delivery method of claim 13, wherein in the step of generating an electric field within the receiving member, voltages are applied according to a predetermined interval of time.

16. The delivery method of claim 13, further comprising a step of setting one or more parameters for delivering the substance prior to generating an electric field within the receiving member.

17. The delivery method of claim 16, wherein the one or more parameters include dosage, delivery interval time and delivery time.

18. The delivery method of claim 13, further comprising a step of selecting a delivery mode prior to generating an electric field within the receiving member.

19. The delivery method of claim 13, wherein in the step of generating an electric field within the receiving member, a low frequency current is employed.

20. The delivery method of claim 13, wherein in the step of causing the substance to permeate through the skin from the receiving member, the substance permeates through the skin in a manner of electrophoresis or iontophoresis.
